(19) United States
(12) Patent Application Publication
(10) Pub. No.: US 2026/0330894 A1
(43) Pub. Date: Oct. 22, 2026

(54) A METHOD FOR DETERMINING ASYMMETRY CONDITIONS IN A MOVING VEHICLE

(71) Applicant: Easy Rain I.S.p.A., Milano (IT)

(72) Inventors: Stefano CASERINI, Milano (IT); Giovanni BLANDINA, Milano (IT); Mauro PIERALLINI, Milano (IT)

(21) Appl. No.: 19/486,419

(22) PCT Filed: May 20, 2024
(86) PCT No.: PCT/IB2024/054875

§ 371 Date: Nov. 21, 2025

(30) Foreign Application Priority Data
May 23, 2023 (IT) 102023000010377

(51) Int. Cl. G07C 5/04

(52) U.S. Cl. CPC G07C 5/04

(57) ABSTRACT

A method for determining the occurrence of an asymmetry condition in a motor vehicle includes determining a reference yaw rate of the vehicle, measuring an actual yaw rate of the vehicle, calculating a difference between the reference yaw rate and the actual yaw rate, reporting the occurrence of an asymmetry condition if the difference between the reference yaw rate and the actual yaw rate is greater than a first threshold value.

### FIELD OF THE INVENTION

The present invention refers to diagnostic methods and systems for motor vehicles. Specifically, the invention was developed with reference to the diagnostics of the travel dynamics of a motor vehicle.

### PRIOR ART

In the travel dynamics of a motor vehicle conditions may often occur wherein the vehicle does not move along a straight line when the control of the steering wheel corresponds to a zero steering angle. The vehicle often follows a path which is subjected to a drift which may be variably perceivable by the driver and/or the passengers of the vehicle: this may be caused by problems with the vehicle setup, by a travel on a road being inclined in the transverse direction, by differences in the characteristics of the ground below the right wheel and the left wheel, by differences in the conditions of the right wheel and of the left wheel.

In some cases, the occurrence of such an asymmetry has no immediate impact on the travel safety of the vehicle. In other instances, which may be as frequent and much more relevant, the asymmetry results in a remarkable worsening of the travel safety of the vehicle, therefore requiring an immediate intervention in order to determine the causes of the asymmetry and the corrections to be implemented. However, although the known art provides numerous examples of methods for a reactive or predictive control of the vehicle dynamics, no solution is available as regards the determination of asymmetry conditions in the vehicle itself, or as regards the determination of the cause(s) and of the provision of corrective measures.

### OBJECT OF THE INVENTION

The present invention aims at solving the technical problems outlined in the foregoing. Specifically, the present invention aims at providing a method for diagnosing asymmetry in the travel of the vehicle which enables not only the determination of the asymmetry, but also the determination of the cause of the asymmetry, so as to enable providing a corrective intervention.

### SUMMARY OF THE INVENTION

The object of the invention is achieved by a method having the features set forth in the claims that follow, which form an integral part of the technical disclosure provided herein in relation to the invention.

### BRIEF DESCRIPTION OF THE FIGURES

The invention will now be described with reference to the annexed Figures, which are provided by way of non-limiting example only and wherein:

FIG. 1 shows a general block diagram of the method according to the invention, and

FIG. 2 shows a block diagram of first steps of a method according to the invention,

FIG. 3 shows a block diagram of second steps of a method according to the invention,

FIG. 4 shows a block diagram of third steps of a method according to the invention,

FIGS. 5 to 8 show block diagrams of the third steps of FIG. 3,

FIGS. 9 to 15 schematically show dynamic models of a motor vehicle or parts thereof, which are employed in the method according to the invention.

### DETAILED DESCRIPTION

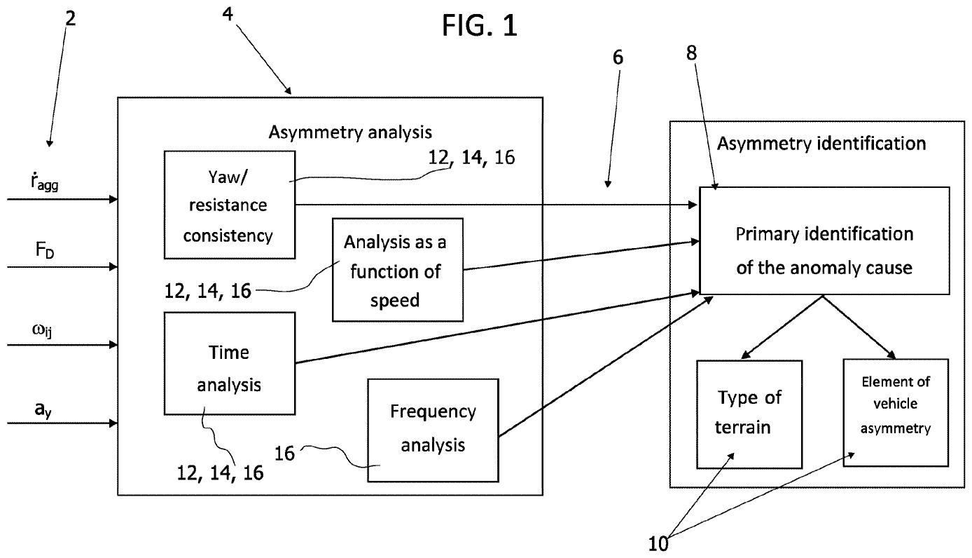

Reference 1 in FIG. 1 generally shows a block diagram of a method for determining asymmetries in the dynamics of a motor vehicle, according to embodiments of the invention.

With reference to the complete functional diagram meaning that the various embodiments may envisage one or more among the functional blocks shown in FIG. 1—the method according to the invention is based on a set of input data 2, a real time computing stage 4, an intermediate set of output data 6, a (real time) analysis stage 8 and a final set of output data 10.

The functional definition within each stage or set mentioned in the foregoing may vary according to the computational needs (or resources) and/or according to the control needs for which the methods is implemented.

In the embodiments which shall meet stricter computing and/or control needs, the general structure is as shown in FIG. 1, wherein the real time calculation stage 4 includes a first calculation module 12 configured for operating based on the data of a powertrain of the vehicle, based on general dynamics data of the vehicle, a second calculation module 14 configured for operating based on general dynamics data of the vehicle, and a third calculation module 16, configured for operating based on dynamics data of the individual wheels of the vehicle.

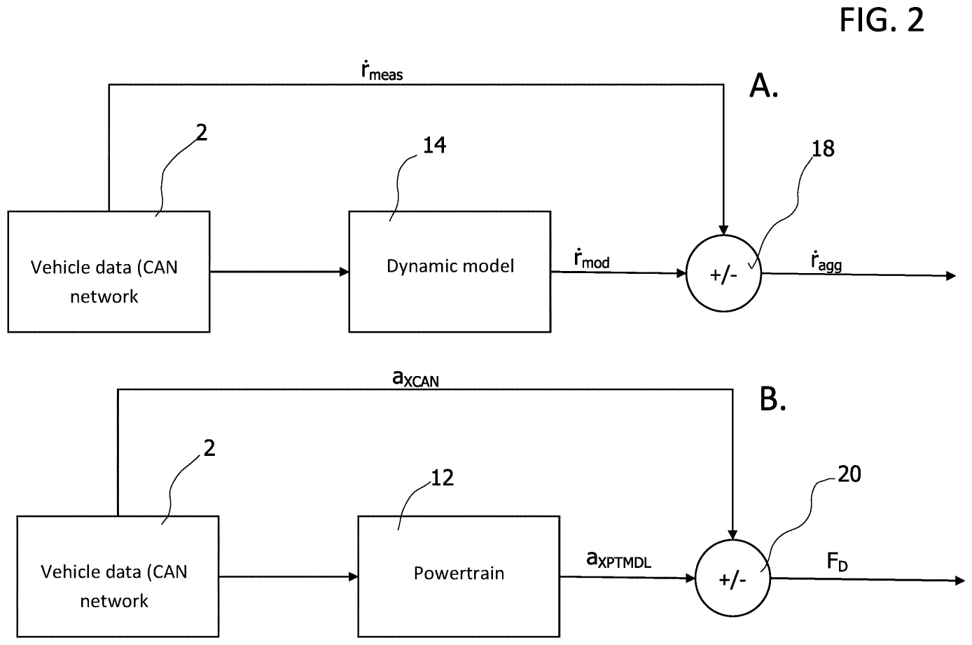

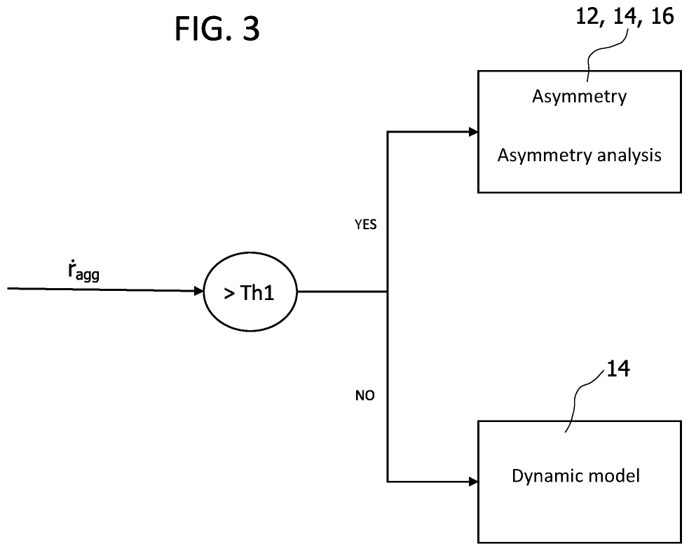

Generally speaking, the method according to the invention enables carrying out two determinations, one depending on the other. The essential determination which the method enables regards the existence of an asymmetry condition which perturbates the vehicle dynamics. Such a determination may be made based on the yaw rate, and consists in determining a reference yaw rate of the vehicle (in the absence of any kind of perturbations), measuring an actual yaw: rate of the vehicle, calculating a difference between the reference yaw rate and the actual yaw rate and reporting the occurrence of an asymmetry condition if the difference between said reference yaw rate and said actual yaw rate is greater than a first threshold value. This is shown in FIGS. 2 and 3, the technical features whereof will be detailed in the following description by reference to modules 12, 14, 16.

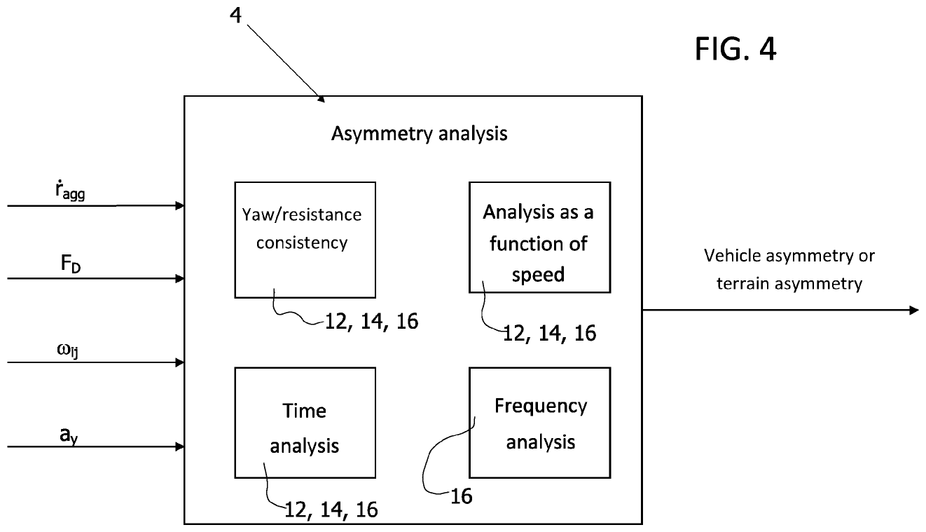

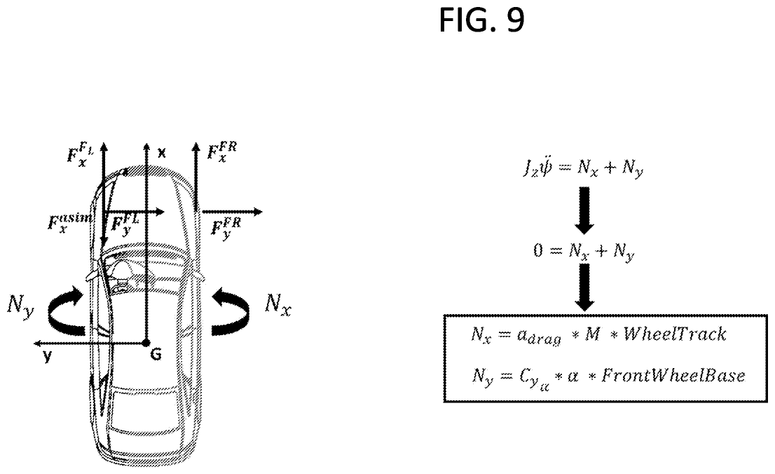

Once this determination is made, the method according to the invention may envisage—if necessary—operating a further determination regarding the cause of the asymmetry. Such a determination may be more layered than the former, and is shown in the diagrams of FIGS. 4 to 8. FIGS. 9 to 13 show a possible schematic representation of the dynamic model of module 14.

### Vehicle Dynamics: Calculation Module 14 (General Dynamics) and Calculation Module 16 (Wheels Dynamics)

The dynamic model corresponding to the assembly of calculation modules 14 and 16 is used for calculating the reference yaw rate of the vehicle (in the absence of perturbations of any kind), measuring the actual yaw rate of the vehicle, and moreover determining a longitudinal force Fₓ^{asim} which results in the difference between the yaw rates mentioned in the foregoing.

The purpose is to create a reference signal, which in this case regards a speed of rotation about vertical axis z, which afterwards may be compared with a direct or indirect measure (e.g., as a derivative of the yaw rate) provided on the CAN network of the vehicle.

Therefore, the first purpose consists in calculating the forces participating in the rotation of the vehicle. If no asymmetry is present, and if the drivetrain has a differential of the open type, the forces along the longitudinal direction x are negligible in the calculation of rotational equilibrium. As regards the forces along the transverse direction y, they are calculated by means of a dynamic model of the vehicle, which may take into account a tyre model (which, for example, may be a linear model). The dynamic model encompasses both the determination of the transverse dynamics of the vehicle and the determination of the longitudinal dynamics.

The dynamic model of the vehicle, obtained from the assembly of modules 14 and 16, is able to associate, to each rotation degree of the steering wheel and to each speed value of the vehicle, a value of the force transmitted from the wheel to the ground Fxᵢⱼ.

The dynamics module of the vehicle 14 employs, as a set of input data, the set of information items present on the CAN network (or on another network of the vehicle, such as module 12 and module 16.

Module 14 performs five main operations, specifically:
acquiring data from the CAN network (or from another data network of the vehicle),
processing the transverse dynamics of the vehicle,
analysing the evolution of the grip forces based on the vehicle dynamics,
analysing the overall contact with the ground.

Module 14 is configured for processing the data on the CAN network (or on another data network of the vehicle, e.g. coming from an inertial measurement unit of the vehicle) in order to obtain an estimate of:
Transverse grip
Longitudinal grip
side-slip/yaw rate

This is useful for evaluating the global grip conditions of the vehicle, and for a few preliminary evaluations on the distribution onto the four tyres of the forces exchanged at the interface with the ground. It is to be noted that such evaluation is independent from the variables considered in the powertrain module 35 12 and therefore, as mentioned in the foregoing, module 14 may provide a different perspective and a different mapping of the dynamic state of the vehicle.

The following list summarizes the sets of input data and output data characterizing a preferred embodiment of the dynamics module of the vehicle 14

### Direct Input Data

Steering angle δ [°]
Longitudinal acceleration \ddot{x} [m/s²]
Transverse acceleration ÿ [m/s²]
Yaw rate r [°/s] or [rad/s]

### Indirect Input Data

None

### Required Parameters

Mass of the vehicle m [kg]
Mass moment of inertia of the vehicle (polar moment of inertia) I_{z} [kg·m²]
Position of the centre of mass of the vehicle (defined by l_{f} and lᵣ—front wheelbase and rear wheelbase)
Coefficient of longitudinal aerodynamic resistance Cₓ [−]
Coefficient of vertical aerodynamic resistance C_{z}—(which is generally very small; it may generally influence the calculation of the vertical forces acting on the motor vehicle, and may ultimately influence the vertical load acting on the wheels).

### Output Data

Lateral grip [N]
Longitudinal grip [N]
Side-slip angle [°]

The calculation of the mass variations due to the use of the vehicle is performed by analysing, in normal grip conditions, the wheel torque data and the acceleration data of the vehicle. As regards the polar moment around axis z, it is possible to refer to the value provided, without the need for updating it during the travel, due to the low sensitivity to variation thereof. If necessary, it is possible to update the value of the polar moment of inertia around axis z on the basis of the mass of the vehicle, which is substantially the only component, among the components taken into account for calculating the moment of inertia, which may undergo variations during the travel. Specifically, the increase or the decrease of the mass respectively generate an increase or a decrease of the polar moment of inertia. In this regard, the same considerations apply which have been provided regarding the updating of the value of the mass of the vehicle: it may be updated by detecting the accelerations during some reference manoeuvres (e.g., low speed manoeuvres) and may be updated based on general dynamic equilibrium equations of the vehicle which contain fixed and known values (e.g. the front and the rear wheelbases) and values which are available on the inertial measurement unit.

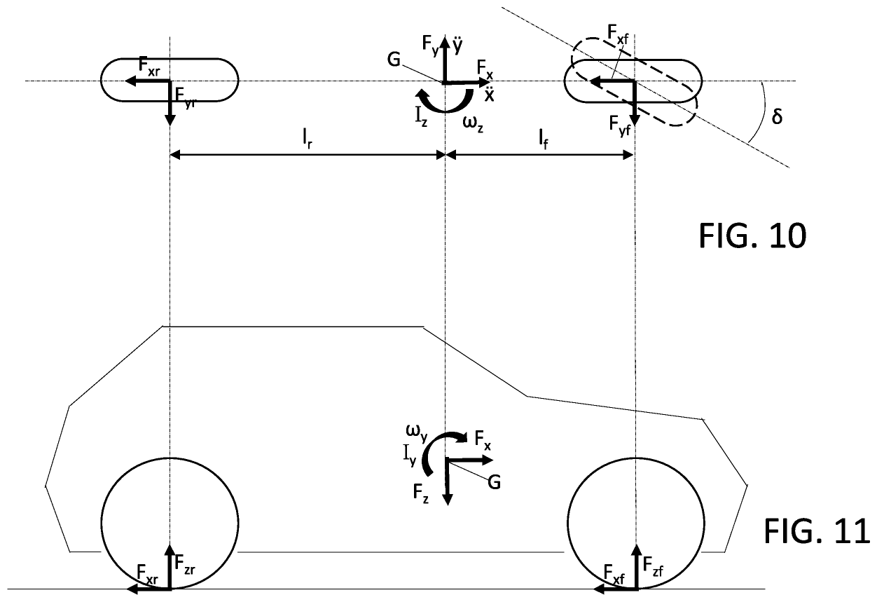

As regards the lateral dynamics of the vehicle, the preferential theoretical premise corresponds to the “bicycle” model shown in FIG. 10 (of course, other calculation models are possible, and therefore the bicycle model must be considered as exemplary). The theoretical reference for calculating the longitudinal dynamics of the vehicle in module 14 is shown in FIG. 11.

In the preferred embodiments, the module 14 operates based on data withdrawn from an inertial measurement unit of the vehicle, which communicates the acceleration components along axis x (\ddot{x}, longitudinal component), along axis y (ÿ, trasverse component) and the rotational acceleration \ddot{ω}_{z} (or \dot{r}, as it corresponds to the time derivative of the yaw rate/yaw speed ω_{z}—which is also denoted as r).

Knowing the mass (m), the wheelbases of the centre of mass (l_{f} and lᵣ—front wheelbase and rear wheelbase) and the polar moment of inertia of the vehicle I_{z} (net of the approximations due to use, as mentioned in the foregoing), from a simple equilibrium to lateral translation and to rotation, by breaking down the forces on the individual wheels along x and y, and by estimating the distribution of the longitudinal forces Fx between the front and rear axles as a function of the vertical acceleration or braking forces (load transfer), it is possible to determine the following forces, referring to the “bicycle” model of FIG. 10:
Fxf: longitudinal force on the front axle
Fxr: longitudinal force on the rear axle
Fyf: transverse force on the front axle
Fyr: transverse force on the rear axle.

Moreover, it is possible to determine the distribution of such forces between the right side and the left side (i.e., on the individual wheels) by knowing the data about the load transfer due to the roll, which data are likewise available on the inertial measurement unit. In this way it is possible to determine the longitudinal forces exchanged between the tyres and the vehicle, which are denoted by references Fxᵢⱼ and Fyᵢⱼ, wherein the index x or Y identifies a longitudinal or a transverse direction, respectively, whereas index i identifies the front (1) or the rear (2) and index j identifies left (1) or right (2).

The determination of the forces Fxf, Fxr, Fyf, Fyr specifically derives from the following set of dynamic equilibrium equations, which are well known in the art:
(General longitudinal and transverse equilibrium)

Fx=m\ddot{x}

Fy=m\tilde{y}
(Equilibrium at transverse translation)

m\tilde{y}=Fyf+Fyr
(Equilibrium at rotation, bicycle model)

I_{z}\dot{r}=Fyf·l_{f}+Fyr·lᵣ
(Equilibrium at translation along axis x)

Fxf+Fxr=Fx
with Fxf, Fxr=function of (Fzf, Fzr)

By dividing the lateral grip forces Fyf, Fyr by the vertical forces acting on the axles (which depend on the distribution of the loads of the vehicle) it is possible to estimate the coefficients of transverse grip for each axle and for each direction
μfx=Fxf/Fzf (coefficient of longitudinal grip of the front axle)
μfy=Fyf/Fzf (coefficient of transverse grip of the front axle)
μrx=Fxr/Fzr (coefficient of longitudinal grip of the rear axle)
μry=Fyr/Fzr (coefficient of transverse grip of the front axle).

In the presence of a steering angle d, the coefficients of grip on the front axle are calculated by breaking down the forces Fyf and Fxf along the steering direction, i.e. by calculating again the longitudinal Fxf (d) and trasverse Fyf (d) components with respect to the middle plane of the steered wheel, thereby obtaining:

Fyf(δ)=Fyf·sen(δ)+Fxf·cos(δ)

Fxf(δ)=Fxf·cos(δ)−Fyf·sen(δ)

The calculation preferably envisages a few simplifications, as various parameters involved in the dynamic equilibrium equation which can be derived from the diagram of FIGS. 10, 11 may vary during the travel. For example, the position of the centre of mass may vary during the travel, and generally it would be necessary to cyclically update the values of the parameters which influence the dynamic equilibrium of the vehicle, but the method according to the invention enables solving said computational problem—as stated in the foregoing—by providing the output data a in discrete configuration, by means of various magnitude levels of the output item of data. By means of such discretization, it is not necessary, for example, to know the exact position of the centre of mass of the vehicle in time, or the mass of the vehicle.

Of course, if the computational effort were not a problem, and if a continuous determination of the output data were possible, it would be necessary to update the vehicle parameters which may vary during the travel according to one or more models which are available in literature and are currently utilized in the electronic control of the vehicle dynamics.

It is possible to set a dynamic equilibrium balance in order to define the average value of the force discharged to the ground by each of the tyres, of course taking into account the distribution of the loads along the vehicle and only depending on input values from the inertial measurement unit.

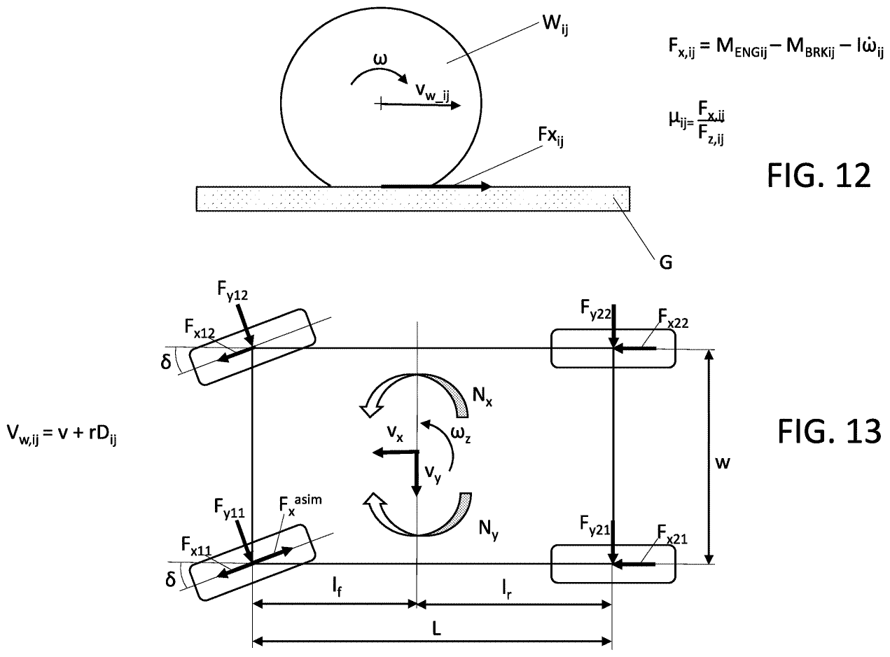

The module 16 (or “wheels module”, FIGS. 12, 13) has the function of repeating the evaluation of the coefficients of grip of the driving wheels with the same purpose as module 14, but it performs the calculation by means of other parameters available on the data network of the vehicle or (CAN other network) in order to increase the reliability level in critical conditions.

The wheels module 17 in turn employs, as the set of input data, the information present on the CAN network (or another network of the vehicle), exactly in the same way as module 12 or module 14.

The module 16 performs two main operations, specifically:
acquiring data from the CAN network (or from another network of the vehicle),
calculating slips and frequency analysis on the individual side of the vehicle.

Module 16 is thus configured for processing the data on the CAN network (or another network of the vehicle) in such a way as to obtain an indication about the forces at stake in the dynamic equilibrium, wheel by wheel.

In order to summarize and to partially anticipate the discussion in the following, the following list provides the enumeration of the input data and of the output data which characterize a preferred embodiment of the wheels module 16.

### Direct Input Data

### Set 1

Wheel speed (front left wheel, front right wheel, rear left wheel, rear right wheel) [rpm] or [rad/s]
Speed of advancement of the vehicle [m/s]

### Set 2

Wheel speed (front left wheel, front right wheel, rear left wheel, rear right wheel) [rpm] or [rad/s]

### Set 3

Longitudinal acceleration [m/s²]
Transverse acceleration [m/s²]

### Indirect Input Data

None

### Required Parameters

Rolling radius of the wheel [m] or [mm];
Mass moment of inertia of the wheel I_{zW} [kgm²];

### Output Data

Frequency analysis

The function of model 16 is to analyse the oscillation frequencies of the angular speed @ in order to determine the origin of the irregularity, specifically whether it is due to problems of setup or to characteristics of the ground, so as to complement the mere determination of the presence of an asymmetry condition.

FIG. 12 shows the model of longitudinal dynamic equilibrium of the wheel, which is involved in the computational process of the wheels module 16 based on the data of Set 1. As regards FIG. 13, it strictly refers to module 16 for the parameters which describe the longitudinal dynamics of the vehicle. The parameters describing the transverse dynamics are essentially employed by module 14, such as the values Fyᵢⱼ which may be derived from the values of transverse grip Fyf and Fyr.

In greater detail, the data on the CAN network (or another network) of the vehicle (Set 2) are used to determine the value of the longitudinal force discharged on the ground by every wheel.

The dynamic equilibrium equation for the wheel is very simple:

F_{x_ij}=M_{eng_ij}−M_{brk_ij}−I_{w_ij}ω_{ij′}
Wherein:
F_{x_ij} is the longitudinal force discharged on the ground by the right/left wheel (i) of the front/rear axle (j)
M_{eng_ij} is the driving torque acting on the right/left wheel (j) of the front/rear axle (i)
M_{brk_ij} is the braking torque acting on the right/left wheel (j) of the front/rear axle (i)
I_{w_ij} is the mass moment of inertia of the right/left wheel (j) of the front/rear axle (i)
ωᵢⱼ′ is the value of the angular acceleration of the right/left wheel (j) of the front/rear axle (i).

This yields the value e of the coefficient of friction/grip μ_{x_ij} for each wheel, which is defined as the ratio F_{x_ij}/F_{z_ij}, Wherein F_{z_ij} is the vertical load acting on the right/left wheel (j) of the front/rear axle (i), which is known from the values of Set 3, which enable estimating the value of the longitudinal load transfer and of the transverse load transfer.

Once the forces Fxᵢⱼ and Fyᵢⱼ are known, the calculation module 14 may perform a calculation of the drift acceleration according to the diagram shown in FIG. 10.

I_{z}\dot{ω}_{z}=Nₓ+N_{y}

0=Nₓ+N_{y}

Nₓ=a_{XCAN}·m·w

N_{y}=Cyα·xx·l_{f}
Wherein:
Nx is the resultant moment, with respect to axis z, of the longitudinal forces (parallel to axis x) [Nm]
Ny is the resultant moment, with respect to axis z, of the transverse forces (parallel to axis y) [Nm]
w is the track width of the vehicle [m]
m is the mass of the vehicle [kg]
a_{XCAN} is the actual (measured) longitudinal acceleration of the vehicle,
Cyα is the cornering stiffness of the front axle
α is the side-slip angle of the front axle, and
l_{f} is the distance between the centre of mass G and the front axle.

Starting from the calculation models described in the foregoing, it is therefore possible to calculate what would be, based on the steering angle, the expected yaw rate for a perfectly symmetrical vehicle travelling on a symmetrical road surface. Such value is denoted with reference \dot{r}_{mod} in the following and in the Figures. The value \dot{r}_{mod} is then compared with the actually measured yaw rate of the vehicle, which is denoted as \dot{r}ₘₑₐₛ in the following and in the Figures.

From the difference between the actually measured yaw rate \dot{r}ₘₑₐₛ and the expected yaw rate \dot{r}_{mod} it is possible to obtain an estimate of an additional yaw rate \dot{r}_{agg} caused by an asymmetry of the vehicle.

The equations derived from calculation module 14 and from calculation module 16 are integrated within equation (2) provided in the following.

\dot{r}_{agg}=(\dot{r}ₘₑₐₛ−\dot{r}_{mod}) (1)

$${\dot{r}}_{mod} = \frac{δ * {V}_{x}}{l + \frac{{mV}_{x}^{2} [ ( {l}_{r} {C}_{{r}_{α}} ) - ( {l}_{f} {C}_{{f}_{α}} ) ]}{2 * {lC}_{f α} {C}_{r α}}} \qquad ( 2 )$$

Wherein
δ is a steering angle (of the steering wheel) applied to the wheels
Vx is the longitudinal speed of the vehicle
m is the mass of the vehicle
lᵣ is the distance between the centre of mass G and the rear axle
l_{f} is the distance between the centre of mass G and the front axle
C_{rα} is the cornering stiffness of the rear axle
C_{fα} is the cornering stiffness of the front axle
l is the track width of the vehicle.

Starting from equation (2), and by performing the subtraction as per equation (1), it is possible to infer the presence of an asymmetry acting on the vehicle dynamics, especially if the difference \dot{r}_{agg}=(\dot{r}ₘₑₐₛ−\dot{r}_{mod})—block 18, FIG. 2A and FIG. 3 3—exceeds a first threshold value Th1. If the threshold Th1 is not exceeded, no further determination is required, and the modules 12, 14, 16 continue to operate by monitoring and processing the respective input parameters. In other words, if the previous equations are in equilibrium (\dot{r}_{agg}=0), then the vehicle shows no asymmetry.

If, on the contrary, the equations are not in equilibrium (\dot{r}_{agg}>Th1), it is possible to determine the side and the magnitude of the asymmetry.

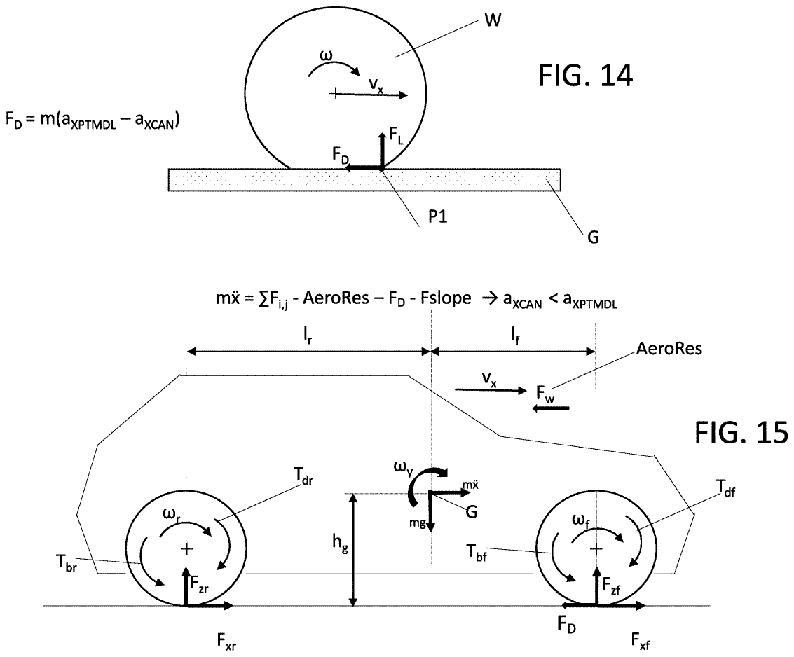

FIG. 2B shows a block diagram of the calculation module 12, which in the following is denoted for brevity “drivetrain module”. In the method according to the invention, the drivetrain module 12 enables determining a resistance to forward motion which does not belong to the normal behaviour of the vehicle. FIGS. 14 and 15 show calculation models implemented within module 12.

Specifically, with reference to FIG. 14, the drivetrain module is configured for processing the set of input data 2 (which includes the data and the parameters which are normally available on the CAN network, without the need of auxiliary sensors or equipment other than normally present on board the vehicle), and specifically the subset concerning the drivetrain, so as to:
determine a reference longitudinal acceleration a_{XPTMDL} of the vehicle in the absence of perturbations
measure an actual longitudinal acceleration a_{XCAN} of the vehicle
calculate a difference between the reference longitudinal acceleration a_{XPTMDL} and the actual longitudinal acceleration a_{XCAN}
determine a corresponding additional resistance value.

The global component of additional resistance FD may thus be expressed as

F_{D}=m(a_{XPTMDL}−a_{XCAN})

i.e., it is a function of the difference between the reference longitudinal acceleration a_{XPTMDL} and the actual longitudinal acceleration a_{XCAN}.

Referring to FIG. 15, the global equation of longitudinal dynamic equilibrium of the vehicle may be written in the following form

m\ddot{x}=ΣF_{x_ij}−AeroRes−F_{D}−Fslope

### Wherein:

\ddot{x} is the longitudinal acceleration of the vehicle
ΣF_{x_i,j} is the sum of the longitudinal forces acting on the right/left wheel (i) of the front/rear axle (j)
AeroRes is the resultant of the aerodynamic resistive forces on the vehicle
Res is the resultant of the additional resistive forces (due to an incorrect setup of the vehicle and/or to different conditions of the ground).

Fslope is the resultant of the resistive or driving forces due to the ground slope (upwards and downwards). In the adopted sign convention, Fslope is positive when resistive, negative when propulsive.

With such premises, the unknown component F_{D} may be determined as a difference with respect to the reference case of absence of asymmetries, substantially by subtracting the following two equations:
ma_{XPTMDL}=ΣF_{x_i,j}—AeroRes−Fslope (reference case, in the absence of asymmetries/perturbations)
ma_{XCAN}=ΣF_{x_i,j}−AeroRes−F_{D}−Fslope (actual situation, in the presence of asymmetries/perturbations)
hence:

m(a_{XPTMDL}−a_{XCAN})=F_{D}

The CAN network of the vehicle provides a plurality of operational and dynamic parameters, including:
the gear engaged
the engine speed of rotation [rpm]
the torque delivered by the engine [Nm]
the braking torque [Nm],
the steering angle [°] the lateral acceleration [m/s²]
the pitch angle [°]

It will be observed that such data may be acquired from any data network of the vehicle, and not necessarily from the CAN network. For this reason, every time the present description mentions the use of data present on the CAN network, it is to be understood that the acquisition may take place either from the CAN network or from any network of the vehicle.

Therefore, by using such data it is possible to calculate, in real time, the value of the reference longitudinal acceleration of the vehicle a_{XPTMDL}, and to compare it to the acceleration a_{XCAN} (block 20, FIG. 2B), which is a further item of data available on the CAN network (or any data network of the vehicle) in order to determine the resistance value F_{D} due to the presence of asymmetries in the travel dynamics.

We will now proceed with a few observations regarding computing. In the calculation of the reference longitudinal acceleration some simplifying assumptions are preferably adopted, due to various parameters which also take part in the dynamic equilibrium equation provided in the foregoing. For example, the mass of the vehicle, as well as the rolling resistance of the individual tyres, may vary as the vehicle travels. Generally speaking, the significant parameters for the vehicle may be calibrated during the travel. Moreover, it is possible to use a sensor fusion logic, in order to keep the influence of the physical variations of such values to a minimum.

For example, the mass of the vehicle may be updated in real time and/or at every engine start, on the basis of the computation of accelerations during low-speed manoeuvres. For example, at the vehicle start it is possible to make use of the initial manoeuvres-which are almost certainly at low speed (exit from a garage or a parking lot/a rest area) in order to detect the vehicle accelerations and estimate the mass when the vehicle starts again, because such mass may have varied with respect to the latest known set of data, e.g. due to the presence of a higher number of passengers on board and/or a larger amount of fuel or luggage.

The availability of the parameter F_{D} is at the basis of one of the determinations which may be made regarding the kind of asymmetry occurring on the vehicle, specifically regarding the distinction between the asymmetries internal to the vehicle (problems of setup) and the asymmetries due to the ground (aquaplaning or uneven road surface).

It is important to highlight that such a distinction may derive from a layering of determinations, wherein the layering is used—inter alia—as a coherence cross-check among said determinations.

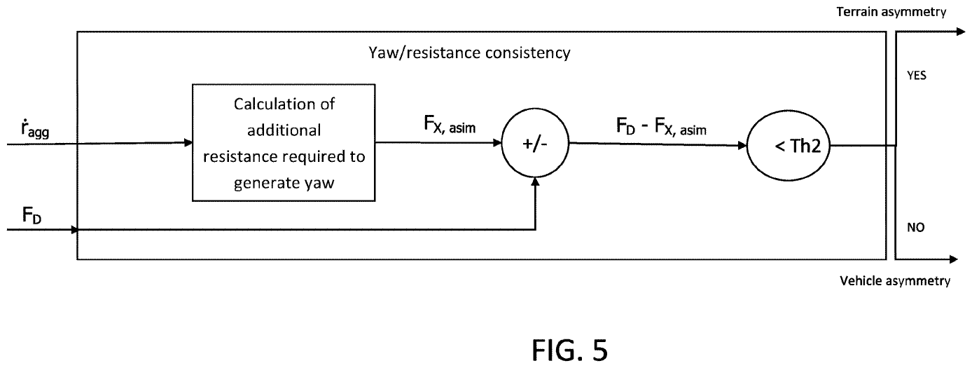

Referring to FIG. 5, the determination which may be made on the basis of parameter F_{D} regards a coherence check between F_{D} and \dot{r}_{agg}. In other words, on the basis of \dot{r}_{agg} there is determined a corresponding additional value of longitudinal force F_{X,ASIM}, which yields a non-zero value (which is greater than threshold Th1) of said \dot{r}_{agg}.

The difference F_{D}−F_{X,ASIM} is then calculated, and if the value of such a difference is less than a second threshold value Th2, then the method determines that the asymmetry is due to the ground. In other words, if the value is less than a second threshold value Th2, then the additional longitudinal resistance F_{D} referred to the ground coincides with the resistance F_{X,ASIM} derived from the difference (above threshold Th1) of the yaw rates, and therefore the asymmetry may reasonably be due to the ground.

On the contrary, in the case of a difference exceeding Th2, obviously there is no coherence between the additional force deriving from the interaction with the ground and the additional force which creates the difference in the yaw rates. Therefore, the asymmetry may reasonably be due to conditions internal to the vehicle, for example to a problem with the vehicle setup. Such a situation arises, for example, if in the presence of a zero steering angle the vehicle sensors are measuring a rotational acceleration around axis z: this may be attributed to an asymmetry due to setup problems (camber, toe-in, both, etc.).

Moreover, it is possible to take into account the dynamic features of the individual wheels. Specifically, the following parameters are considered:
The wheel speed of rotation [rad/s]
The wheel rotational acceleration [rad/s²]
The tyre inflation pressure [bar]

On the basis of such parameters, it is possible to calculate whether a rotation at a different speed of an individual wheel may be due to a flat tyre or to an incorrect camber (or toe-in).

Moreover, on the basis of the speed of rotation and of the rotational acceleration it is possible to calculate a coefficient of the road surface unevenness. This is useful for distinguishing between the cases wherein the asymmetry is due to conditions internal to the vehicle and the cases wherein the asymmetry originates from the road surface conditions.

As regards the asymmetry due to conditions internal to the vehicle, the attention mainly focuses on parameters such as the inflation pressure of the tyres, the camber angles and the toe-in angles.

Thanks to calculation module 14 it is possible to understand whether the vehicle is subjected to a side thrust from one of the wheels. If this is the case, this is generally due to an incorrect toe-in angle.

Moreover, it is checked whether the side thrust varies as a function of the travelling speed of the vehicle (as would be the case if the asymmetry is due to a road surface which causes aquaplaning).

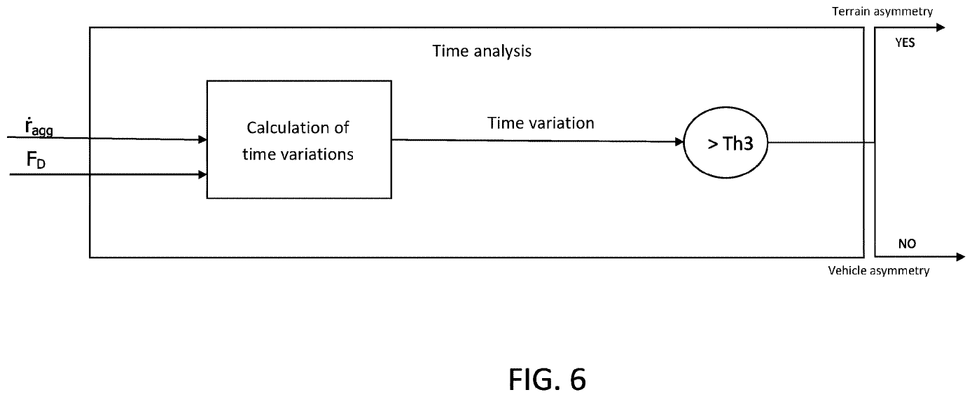

As an alternative or in combination with the determination as per FIG. 5, it is possible to carry out the determination as per FIG. 6, which is based on the analysis of the time duration of the variations of parameters F_{D} and \dot{r}_{agg}. As the physical phenomenon is concerned, a condition of asymmetry due to the travel on uneven road surfaces (or on road surfaces causing aquaplaning) is generally short lasting. I For this reason, the determination is based on the fact that the duration of the asymmetry condition exceeds a third threshold value Th3. If this is true, the asymmetry is unlikely to be due to the road surface, whereas it is likely to be due to a problem of setup, which does not disappear as the vehicle travels on. If the duration does not exceed the threshold Th3, then the asymmetry is likely to be due to the road surface.

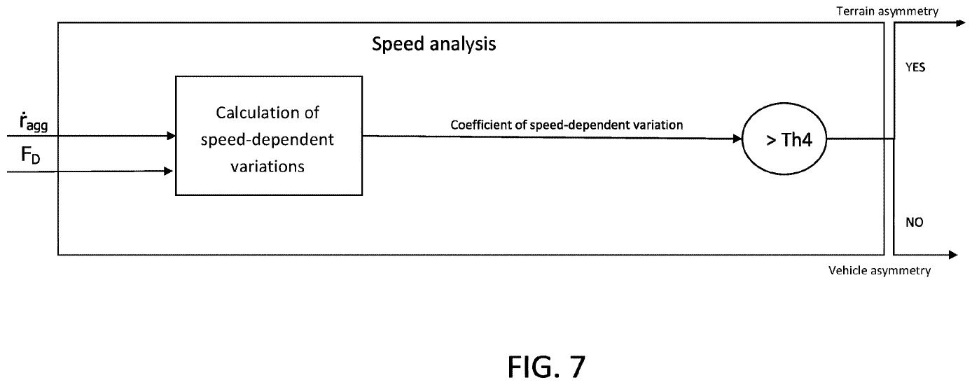

Referring to FIG. 7, as an alternative or in combination with the determination as per FIGS. 5 and 6, an analysis is carried out of the variation of the parameters F_{D} and \dot{r}_{agg} depending on the vehicle speed, therefore determining a corresponding coefficient of variation with respect to the speed. Some forces inherently depend on the speed, such as e.g. the aerodynamic forces. The analysis performed takes into account the fashion in which the forces exchanged with the ground and which cause asymmetry (hydrodynamic forces and ground resistance) undergo a clearly perceptible variation as the vehicle speed changes. If the vehicle should slow down, such forces would decrease, and the asymmetry would become less evident. Based on this logic, if the coefficient of variation exceeds a fourth threshold value Th4, the most likely determination is that the asymmetry is due to the ground (e.g. in the case of aquaplaning). On the contrary, if the coefficient is less than threshold Th4, the most likely determination is that the asymmetry is due to conditions internal to the vehicle.

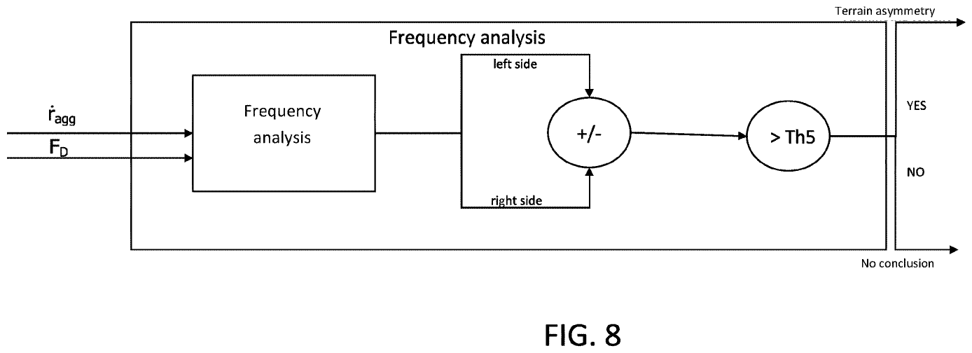

Referring to FIG. 8, as an alternative or in combination with the determination as per FIGS. 5, 6 and 7, a frequency analysis is carried out on all the wheels of the vehicle, with particular reference to the speeds of rotation. If the frequencies of the speeds of rotation are different between the left and the right side, i.e. if their difference is greater than a fifth threshold value Th5, it is possible to exclude that the asymmetry is due to conditions internal to the vehicle, whereas the likely determination is the occurrence of an asymmetry of the road surface (a typical situation is travelling with two wheels on the road track and two wheels on the roadside, or anyway outside the road track). On the contrary, if the frequencies are similar on the right side and on the left side of the vehicle, it is possible to exclude that the asymmetry is due to the conditions of the road surface, while the likely determination is the presence of an asymmetry due to conditions internal to the vehicle.

If on the tyres there are provided pressure sensors, in the logic verification it is possible to also make use, with higher accuracy, of the speed of the wheels. As a matter of fact, if the tyre pressure is known it is possible to calculate the rolling radius with precision. Once the latter is known, it is possible to normalize the speed of rotation of the tyres, in such a way as to eliminate any variation of the speed of rotation (with respect to the other wheels) which is caused by a different rolling radius. Once such alignment has been accomplished, every difference (even of small entity) in the speed of rotation between the wheels may be attributed to an incorrect camber of the wheel. In such a fashion, in addition to identifying an incorrect setup, it is possible to calculate which is the wheel having an incorrect camber or toe-in.

As regards the calculation of asymmetry due to the road surface (e.g., single side aquaplaning conditions, single side gravel, single side snow), the evaluation is complementary to the previous one.

First of all, it is assumed that the vehicle, at the start and before being able to provide elements useful for detecting an asymmetry of the road surface, must operate a check on the asymmetry due to conditions internal to the vehicle. By means of parameters which are calibrated in time based on the recorded data, the vehicle will set a zero reference based on the current setup (which may be either correct or incorrect).

Once the zero reference has been found, the vehicle is able to detect an asymmetry due to the ground, and therefore the same set of logic checks is carried out as described in the foregoing, obviously by performing complementary determinations (in other words: if a determination corresponds to an asymmetry condition caused by an incorrect setup of the vehicle or, generally speaking, by a condition internal to the vehicle, the complementary—or opposite—determination corresponds to an asymmetry condition due to the ground).

The following lists the detected conditions which result in either determination.

### Situation 1:

The frequency of the speed of rotation of the wheels of the right side and of the left side is identical or substantially identical: incorrect setup

No variation of the asymmetry with respect to speed: incorrect setup

No variation of the asymmetry in time: incorrect setup

Additional resistance which does not account for the rotation of the vehicle about the vertical axis (in terms of yaw rate)->incorrect setup.

### Situation 2:

Different frequencies of the speeds of rotation of the wheels of the right and the left side: asymmetry of the road surface

The asymmetry varies as the speed varies: asymmetry of the road surface (probable aquaplaning)

The asymmetry varies in time: asymmetry of the road surface

Additional resistance which accounts for the rotation of the vehicle about the vertical axis z (in terms of yaw rate): asymmetry of the road surface.

Once the above-mentioned determinations (which may correspond to an analysis of probability) have been calculated, they are used in a decision analysis which returns, as a result, the cause of the asymmetry.

Generally speaking, based on the calculated probability and on a necessary validation time, the final decision may be more or less rapid. If the anomaly is more apparent, and therefore more dangerous for the vehicle, the achievement of the decision will be more rapid, because the evidence of an anomaly will result in higher probability values.

In any case, it is useful to point out that in the preferred embodiments none of the previously described determinations is deemed to be inherently necessary and sufficient to infer the real cause of the anomaly. All conditions are layered, in order to compose a conditional probability which enables the achievement of the final decision. The general logic diagram is always the one shown in FIG. 1.

On an operational level, the information about an incorrect setup is useful because it allows the driver, for example, to replace the tyres or to adjust the toe-in angle before the vehicle components are seriously damaged. The information of ground asymmetry, on the contrary, may be used by the control units of the vehicle in order to optimize the delivery of the driving and/or braking torque.

1. A method for determining an occurrence of an asymmetry condition in a motor vehicle, comprising:
determining a reference yaw rate (\dot{r}_{mod}) of the vehicle,
measuring an actual yaw rate of the vehicle (\dot{r}ₘₑₐₛ),
calculating a difference (\dot{r}_{agg}) between said reference yaw rate (mod) and said actual yaw rate (\dot{r}ₘₑₐₛ), and
reporting the occurrence of the asymmetry condition if the difference (\dot{r}_{agg}) between said reference yaw rate (\dot{r}_{mod}) and said actual yaw rate (\dot{r}ₘₑₐₛ) is greater than a first threshold value (Th1).

2. The method according to claim 1, comprising, when the difference (\dot{r}_{agg}) between said reference yaw rate (\dot{r}_{mod}) and said actual yaw rate is greater than the first threshold value (Th1):
determining a reference longitudinal acceleration (a_{XPTMDL}) of the vehicle,
measuring an actual longitudinal acceleration of the vehicle (a_{XCAN}),
calculating a difference between said reference longitudinal acceleration (a_{XPTMDL}) and said actual longitudinal acceleration (a_{XCAN}), and
determining an additional resistance (F_{D}) as a function of the difference between said reference longitudinal acceleration (a_{XPTMDL}) and said actual longitudinal acceleration (a_{XCAN}).

3. The method according to claim 2, further comprising:
determining a value of an additional longitudinal force (F_{X,ASIM}) resulting in the calculated value of said difference (\dot{r}_{agg}) between the reference yaw rate (\dot{r}_{mod}) and the actual yaw rate (\dot{r}ₘₑₐₛ),
calculating a difference between a value of said additional resistance (F_{D}) and said value of the additional longitudinal force (F_{X,ASIM}),
reporting an asymmetry due to the ground if the calculated difference between the value of said additional resistance (F_{D}) and the value of said additional longitudinal force (F_{X,ASIM}) is less than a second threshold value (Th2), and
reporting an asymmetry due to conditions internal to the vehicle if the calculated difference between the value of said additional resistance (F_{D}) and the value of said additional longitudinal force (F_{X,ASIM}) is greater than said second threshold value (Th2).

4. The method according to claim 2, further comprising
determining a time duration of variations in said additional force resistance (F_{D}) and said difference (\dot{r}_{agg}) between the reference yaw rate (\dot{r}_{mod}) and the actual yaw rate (\dot{r}ₘₑₐₛ),
reporting an asymmetry due to the ground if the time duration of said variations is less than a third threshold value (Th3),
reporting an asymmetry due to internal vehicle conditions if the time duration of said variations is greater than said third threshold value (Th3).

5. The method according to claim 2, comprising:
determining a coefficient of variation of said additional resistance (F_{D}) and said difference (\dot{r}_{agg}) between said reference yaw rate (\dot{r}_{mod}) and said actual yaw rate (\dot{r}ₘₑₐₛ) with respect to vehicle speed,
reporting an asymmetry due to the ground if said coefficient of variation has a value greater than a fourth threshold value (Th4), and
reporting an asymmetry due to conditions internal to the vehicle if said coefficient of variation has a value below said fourth threshold value (Th4).

6. The method according to claim 2,
further comprising:
determining a frequency of a speed of rotation of each wheel of the vehicle,
determining a difference in the frequency of speed of rotation between wheels of a right side of the vehicle and wheels of a left side of the vehicle,
reporting an asymmetry due to the ground if the difference in frequency of speed of rotation between wheels on the right side of the vehicle and wheels on the left side of the vehicle is greater than a fifth threshold value (Th5), and
reporting an asymmetry due to conditions internal to the vehicle if the difference in frequency of speed of rotation between the wheels on the right side of the vehicle and the wheels on the left side of the vehicle is less than said fifth threshold value (Th5).

7. The method according to claim 1, wherein said reference yaw rate (\dot{r}_{mod}) is associated to a condition of no asymmetry.

8. The method according to claim 2, wherein said reference longitudinal acceleration (a_{XPTMDL}) is associated to a condition of no asymmetry.

9. The method according to claim 2, wherein said additional resistance (F_{D}) has a longitudinal direction.

10. The method according to claim 3, wherein said asymmetry due to conditions internal to the vehicle comprises an incorrect setup condition.
